(19) United States
(12) Patent Application Publication
(10) Pub. No.: US 2025/0334973 A1
(43) Pub. Date: Oct. 30, 2025

(54) MOBILE BODY CONTROL DEVICE, MOBILE BODY CONTROL METHOD, AND STORAGE MEDIUM

(71) Applicant: HONDA MOTOR CO., LTD., Tokyo (JP)

(72) Inventors: Kohei Tsuda, Wako-shi (JP); Sango Matsuzaki, Wako-shi (JP)

(21) Appl. No.: 19/186,680

(22) Filed: Apr. 23, 2025

(30) Foreign Application Priority Data
Apr. 30, 2024 (JP) 2024-073815

(51) Int. Cl. G05D 1/622; G05D 111/10

(52) U.S. Cl. CPC G05D 1/637; G05D 2111/10

(57) ABSTRACT

A mobile body control device includes a storage medium configured to store computer-readable instructions, and a processor that is connected to the storage medium, in which the processor executes the computer-readable instructions to recognize surrounding conditions of a mobile body on the basis of at least an image of the surrounding conditions of the mobile body, generate a route composed of via points to be passed through by the mobile body, which is a route from the mobile body to a destination, on the basis of the recognized surrounding conditions and the set destination, control the mobile body so that the mobile body moves along the generated route to the destination via the via points, and when the surrounding conditions include an obstacle, determine whether to modify the route on the basis of at least one of a first area using the obstacle as a reference, a second area positioned outside the first area using the obstacle as a reference, and a third area positioned outside the second area using the obstacle as a reference, and the route.

### CROSS-REFERENCE TO RELATED APPLICATION

Priority is claimed on Japanese Patent Application No. 2024-073815, filed Apr. 30, 2024, the contents of which are incorporated herein by reference.

### BACKGROUND

### Field of the Invention

The present invention relates to a mobile body control device, a mobile body control method, and a storage medium.

### Description of Related Art

Conventionally, a robot that guides a user to a desired place or transports luggage is known (refer to, for example, Japanese Unexamined Patent Application, First Publication No. 2012-111011). The robot refers to a movement speed database in which a maximum movement speed is associated with each area in an environment, and moves at a speed that is up to the set maximum movement speed.

Generally, when a route to a destination is generated, a robot in the conventional technology generates a plurality of via points and generates a route by connecting these via points. Thereafter, the robot travels toward the destination while passing through these via points. However, in the conventional technology, the route is generated using a point regarded as a mass point with no volume, so that the robot may get close to an obstacle excessively.

### SUMMARY

The present invention has been made in consideration of these circumstances, and one of its objects is to provide a mobile body control device, a mobile body control method, and a storage medium that can generate a route while preventing a robot from getting close to an obstacle excessively.

The mobile body control device, the mobile body control method, and the storage medium of the present invention have adopted the following configuration.
(1): A mobile body control device according to one aspect of the present invention includes a storage medium configured to store computer-readable instructions, and a processor that is connected to the storage medium, in which the processor executes the computer-readable instructions to recognize surrounding conditions of a mobile body on the basis of at least an image of the surrounding conditions of the mobile body, generate a route composed of via points to be passed through by the mobile body, which is a route from the mobile body to a destination, on the basis of the recognized surrounding conditions and the set destination, control the mobile body so that the mobile body moves along the generated route to the destination via the via points, and when the surrounding conditions include an obstacle, determine whether to modify the route on the basis of at least one of a first area using the obstacle as a reference, a second area positioned outside the first area using the obstacle as a reference, and a third area positioned outside the second area using the obstacle as a reference, and the route.
(2): In the aspect of (1) described above, the processor may determine to modify the route when the mobile body has come into contact with the first region while moving along the route.
(3): In the aspect of (1) described above, the processor may determine to modify the route when it is determined that the mobile body has come into contact with the first region under an assumption that the mobile body has moved along the route.
(4): In the aspect of (1) described above, the processor may generate the route so that the mobile body does not pass through the first area and preferentially passes through the third area over the second area.
(5): In the aspect of (1) described above, the processor may generate the route so that the mobile body passes through the second area without passing through the first area when the second area does not include another obstacle even if the third area includes the other obstacle.
(6): In the aspect of any one of (1) to (5) described above, the first area may be an area obtained by expanding an area representing the obstacle by a portion corresponding to a radius of the mobile body.
(7): In the aspect of any one of (1) to (5) described above, the second area may be an area obtained by expanding the area representing the obstacle by a portion obtained by adding a first predetermined distance to the radius of the mobile body.
(8): In the aspect of (7) described above, the third area may be an area obtained by expanding the area representing the obstacle by a portion obtained by adding a second predetermined distance, which is equal to or greater than the first predetermined distance, to the radius of the mobile body.
(9): A mobile body control method according to another aspect of the present invention includes, by a computer, recognizing surrounding conditions of a mobile body on the basis of at least an image of the surrounding conditions of the mobile body, generating a route composed of via points to be passed through by the mobile body, which is a route from the mobile body to a destination, on the basis of the recognized surrounding conditions and the set destination, controlling the mobile body so that the mobile body moves along the generated route to the destination via the via points, and when the surrounding conditions include an obstacle, determine whether to modify the route on the basis of at least one of a first area using the obstacle as a reference, a second area positioned outside the first area using the obstacle as a reference, and a third area positioned outside the second area using the obstacle as a reference, and the route.
(10): A storage medium that stores a program according to still another aspect of the present invention is a computer-readable non-transitory storage medium that stores a program causing a computer to execute recognizing surrounding conditions of a mobile body on the basis of at least an image of the surrounding conditions of the mobile body, generating a route composed of via points to be passed through by the mobile body, which is a route from the mobile body to a destination, on the basis of the recognized surrounding conditions and the set destination, controlling the mobile body so that the mobile body moves along the generated route to the destination via the via points, and when the surrounding conditions include an obstacle, determine whether to modify the route on the basis of at least one of a first area using the obstacle as a reference, a second area positioned outside the first area using the obstacle as a reference, and a third area positioned outside the second area using the obstacle as a reference, and the route.

According to the aspects (1) to (10), it is possible to generate a route while preventing a robot from getting close to an obstacle excessively.

### BRIEF DESCRIPTION OF THE DRAWINGS

FIG. 1 is a diagram which shows an example of a configuration of a mobile body system including a mobile body.

FIG. 2 is a diagram for describing an example of a usage mode of the mobile body.

FIG. 3 is a diagram for describing a guidance mode.

FIG. 4 is a perspective view which shows the mobile body.

FIG. 5 is a diagram which shows an example of a functional configuration of the mobile body.

FIG. 6 is a diagram which shows an example of a route generated by a route generation unit.

FIG. 7 is a diagram which shows another example of the route generated by the route generation unit.

FIG. 8 is a diagram which shows another example of the route generated by the route generation unit.

FIG. 9 is a flowchart which shows an example of a flow of processing executed by a control device.

### DESCRIPTION OF EMBODIMENTS

Hereinafter, an embodiment of a mobile body control device, a mobile body control method, and a storage medium of the present invention will be described with reference to drawings.

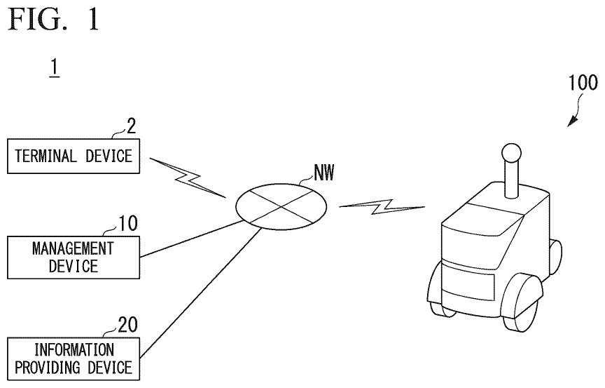

FIG. 1 is a diagram which shows an example of a configuration of a mobile body system 1 including a mobile body 100. The mobile body system 1 includes, for example, one or more terminal devices 2, a management device 10, an information providing device 20, and one or more mobile bodies 100. These communicate with each other via, for example, a network NW. The network NW is, for example, any network such as a LAN, a WAN, or an Internet line.

### [Terminal Device]

The terminal device 2 is, for example, a computer device such as a smartphone or a tablet terminal. The terminal device 2 requests, for example, provision of authority to use the mobile body 100 from the management device 10 on the basis of an operation of a user, and acquires information indicating that use has been permitted.

### [Management Device]

The management device 10 grants the user of the terminal device 2 the authority to use the mobile body 100 and manages reservations for use of the mobile body 100 in response to a request from the terminal device 2. The management device 10 generates and manages schedule information in which, for example, identification information of a user registered in advance is associated with a date and time of reservation for the use of the mobile body 100.

### [Information Providing Device]

The information providing device 20 provides the mobile body 100 with map information such as a position of the mobile body 100, an area in which the mobile body 100 moves, and surroundings of the area. In response to a request from the mobile body 100, the information providing device 20 may generate a route to a destination of the mobile body 100 and provide the generated route to the mobile body 100.

### [Mobile Body]

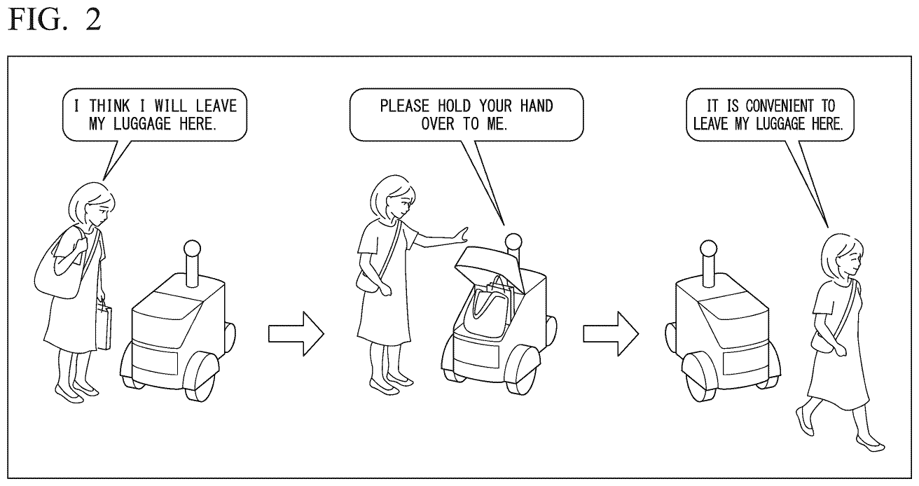

The mobile body 100 is used by the user in the following usage mode. FIG. 2 is a diagram for describing an example of the usage mode of the mobile body 100. The mobile body 100 is disposed at, for example, a predetermined position in a facility or town. When the user wants to use the mobile body 100, the user can start using the mobile body 100 by operating an operation unit (not shown) of the mobile body 100, or by operating the terminal device 2. For example, when the user goes shopping and has a lot of luggage, the user starts using the mobile body 100 and puts the luggage in a storage compartment of the mobile body 100. Then, the mobile body 100 moves together with the user so as to autonomously follow the user. The user can continue shopping or move to a next destination with the luggage stored in the mobile body 100. For example, the mobile body 100 moves together with the user while moving along a sidewalk or a crosswalk on the roadway. The mobile body 100 can move in areas where pedestrians can pass, such as roadways and sidewalks. For example, the mobile body 100 may be used in indoor or outdoor facilities or private areas, such as shopping centers, airports, parks, and theme parks, and can move in areas where pedestrians can pass.

The mobile body 100 may be capable of moving autonomously in a mode such as a guidance mode or an emergency mode, in addition to (or instead of) a following mode in which the mobile body 100 follows the user as described above.

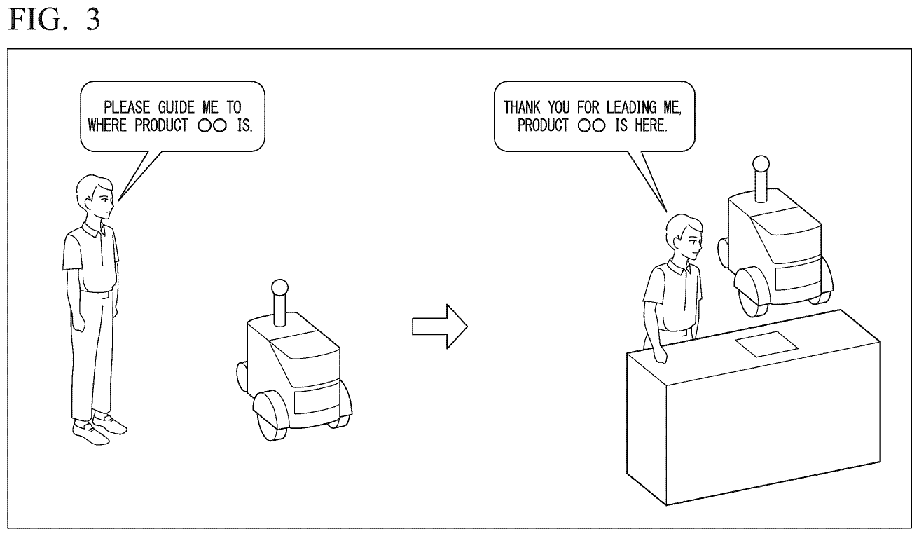

FIG. 3 is a diagram for describing the guidance mode. The guidance mode is a mode in which the mobile body 100 guides the user to a destination specified by the user, and autonomously moves in front of the user in accordance with a moving speed of the user to guide the user. As shown in FIG. 3, when the user is looking for a predetermined product in a shopping center, the user requests the mobile body 100 to guide the user to the position of the predetermined product, and the mobile body 100 guides the user to the position of the predetermined product. This allows the user to easily find the predetermined product. When the mobile body 100 is used in a shopping center, the mobile body 100 or the information providing device 20 holds information in which a position of a product, a position of a store, a position of a facility in the shopping center, and the like are associated with map information, and map information of the shopping center. This map information includes detailed map information including widths of roads and passages, and the like. In addition, the guidance mode may be a mode in which the user is guided to a destination estimated on the basis of information such as map information and operations of the user (including orientation, speed, behavior, and the like) even if the user does not specify the destination. For example, the mobile body 100 or the information providing device 20 may detect the orientation of the user based on an image captured by the camera 180 which will be described below, set a straight line representing the detected orientation of the user, and estimate a place that intersects with the straight line or a place closest to the straight line as a destination among places registered in the map information. For example, the mobile body 100 or the information providing device 20 may also register a plurality of gestures (for example, a gesture for drinking a drink, a gesture for charging a mobile phone, and the like) in advance, and collate the behavior of the user detected based on the image with a registered gesture to estimate a place that satisfies a request of the gesture (for example, a restaurant, a charging facility, or the like) as a destination among the places stored in the map information. In addition, for example, the mobile body 100 or the information providing device 20 may estimate a place that has been most frequently set as a destination by the user in the past among facilities stored in the map information as the destination.

The emergency mode is a mode in which the mobile body 100 moves autonomously to seek help from nearby people or facilities to help the user when something unusual happens to the user (for example, when the user falls) while it moves with the user. In addition to (or instead of) following or guiding as described above, the mobile body 100 may move while it maintains a moderate distance from the user.

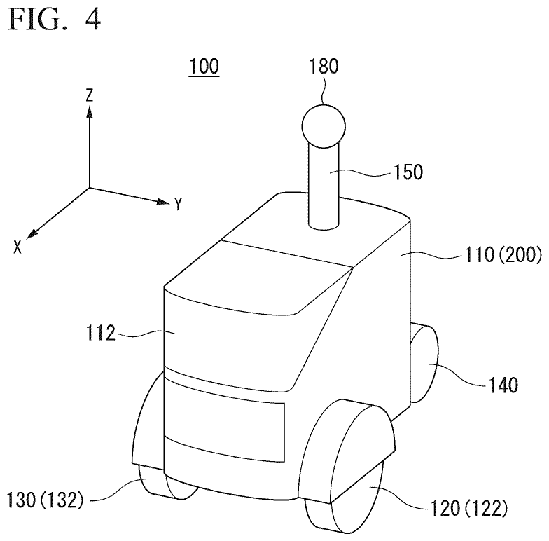

FIG. 4 is a perspective view which shows the mobile body 100. In the following description, a forward direction of the mobile body 100 is a positive x direction, a rearward direction of the mobile body 100 is a negative x direction, a leftward direction from the positive x direction, which is a width direction of the mobile body 100, is a positive y direction, the rightward direction is a negative y direction, and a height direction of the mobile body 100, which is a direction perpendicular to the x and y directions, is a positive z direction.

The mobile body 100 includes, for example, a base body 110, a door section 112 provided on the base body 110, and wheels (a first wheel 120, a second wheel 130, and a third wheel 140) attached to the base body 110. For example, a user can open the door section 112 to put luggage into a storage compartment provided on the base body 110 or take luggage out of the storage compartment. The first wheel 120 and the second wheel 130 are driving wheels, and the third wheel 140 is an auxiliary wheel (driven wheel). The mobile body 100 may be movable using a constituent other than wheels, such as caterpillars.

A cylindrical support body 150 extending in the positive z direction is provided on a surface of the base body 110 in the positive z direction. A camera 180 that captures an image of surroundings of the mobile body 100 is provided on an end of the support body 150 in the positive z direction. A position where the camera 180 is provided may be any position different from the above.

The camera 180 is, for example, a camera capable of capturing images of a periphery of the mobile body 100 at a wide angle (for example, 360 degrees). The camera 180 may include a plurality of cameras. The camera 180 may be realized by combining, for example, a plurality of 120-degree cameras or a plurality of 60-degree cameras.

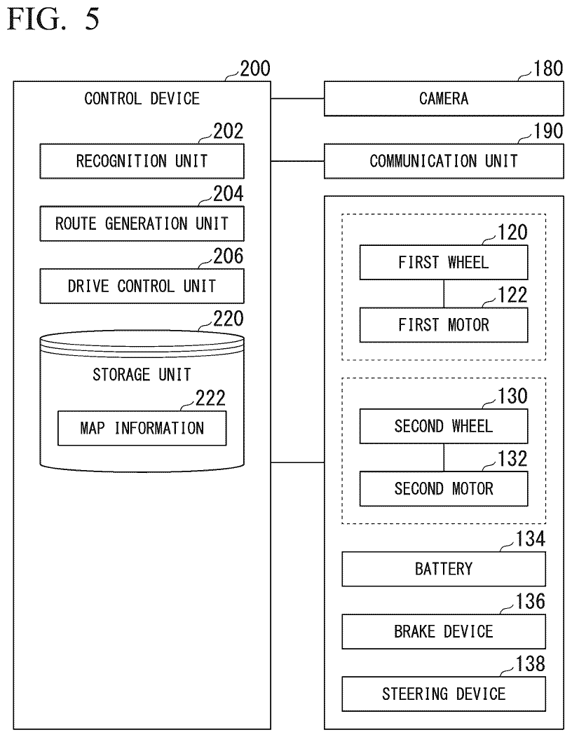

FIG. 5 is a diagram which shows an example of a functional configuration of the mobile body 100. In addition to the functional configuration shown in FIG. 4, the mobile body 100 further includes a first motor 122, a second motor 132, a battery 134, a brake device 136, a steering device 138, a communication unit 190, and a control device 200. The first motor 122 and the second motor 132 are operated by power supplied to the battery 134. The first motor 122 drives the first wheel 120, and the second motor 132 drives the second wheel 130. The first motor 122 may be an in-wheel motor provided on a wheel of the first wheel 120, and the second motor 132 may be an in-wheel motor provided on a wheel of the second wheel 130.

The brake device 136 outputs brake torque to each wheel on the basis of an instruction from the control device 200. The steering device 138 includes an electric motor. For example, the electric motor applies force to a rack-and-pinion mechanism on the basis of the instruction from the control device 200 to change a direction of the first wheel 120 or the second wheel 130, thereby changing a traveling route of the mobile body 100.

The communication unit 190 is a communication interface for communicating with the terminal device 2, the management device 10, or the information providing device 20.

### [Control Device]

The control device 200 includes, for example, a recognition unit 202, a route generation unit 204, a drive control unit 206, and a storage unit 220. The recognition unit 202, the route generation unit 204, and the drive control unit 206 are realized by, for example, a hardware processor such as a central processing unit (CPU) executing a program (software). Some or all of these components may be realized by hardware (a circuit unit; including circuitry) such as a large scale integration (LSI), an application specific integrated circuit (ASIC), a field-programmable gate array (FPGA), or a graphics processing unit (GPU), or may be realized by software and hardware in cooperation. A program may be stored in advance in a storage device such as a hard disk drive (HDD) or a flash memory (a storage device having a non-transitory storage medium), or may be stored in a removable storage medium such as a DVD or a CD-ROM (a non-transient storage medium), and may be installed by mounting the storage medium in a drive device. The storage unit 220 is realized by a storage device such as a HDD, a flash memory, or a random access memory (RAM). The storage unit 220 stores map information 222 referenced by the mobile body 100. The map information 222 is, for example, map information such as the position of the mobile body 100, the area in which the mobile body 100 moves, and the surroundings of the area, provided by the information providing device 20. A part or all of the functional constituents included in the control device 200 may be included in another device. For example, the mobile body 100 may communicate with the other device and cooperate to control the mobile body 100.

The recognition unit 202 recognizes a position (a distance from the mobile body 100 and a direction relative to the mobile body 100), and a state such as a speed or acceleration of objects around the mobile body 100 on the basis of, for example, an image captured by the camera 180. Objects include a traffic participant and an obstacle present in facilities and on roads. The recognition unit 202 recognizes and tracks a user of the mobile body 100. For example, the recognition unit 202 tracks the user on the basis of an image (for example, a facial image of the user) of the user registered when the user uses the mobile body 100, or a facial image of the user provided by the terminal device 2 or the management device 10 (or a feature amount obtained from the facial image of the user). The recognition unit 202 recognizes a gesture made by the user. The mobile body 100 may be provided with a detection unit other than a camera, such as a radar device or LIDAR. In this case, the recognition unit 202 recognizes the surrounding conditions of the mobile body 100 using a result of detection from a radar device or LIDAR instead of (or in addition to) an image.

The route generation unit 204 generates a route to a destination on the basis of the surrounding conditions of the mobile body 100 recognized by the recognition unit 202. Here, the destination represents the user itself to be followed or a point within a predetermined range from the user when the mobile body 100 is in the following mode. For example, the route generation unit 204 may set the destination to a predetermined point diagonally behind the user so that the mobile body 100 can follow the user and be visible to the user. In addition, for example, the route generation unit 204 may determine the destination to keep it within a predetermined distance on the basis of a walking speed of the user to prevent the mobile body 100 from getting too far away from the user. When the mobile body 100 is in the guidance mode, the destination represents, for example, a point of a product or facility set by the user. In this case, the user specifies the point of a product or facility, and thereby the mobile body 100 collates the specified point of a product or facility with the map information 222, and sets the specified point of a product or facility as a result of the collation as a destination. In addition, when the point set by the user is far from a current position of the mobile body 100 in the guidance mode, the route generation unit 204 may set the point set by the user as a final destination and set a point within a predetermined range from the current position as a tentative destination. In the guidance mode, the user does not necessarily have to set the destination, and the mobile body 100 may predict a direction in which the user will move and move autonomously in front of the user in accordance with the moving speed of the user. At this time, the route generation unit 204 may set the destination of the mobile body 100 to a point within a predetermined range in front of the user.

The route is a route that allows the mobile body 100 to reach the destination reasonably, taking into account the forward direction of the mobile body 100 (that is, the x direction of the mobile body 100). The route generation unit 204 generates a plurality of via points for reaching the destination from the current position, and generates a route by connecting the plurality of these via points. For example, the route generation unit 204 calculates a risk for each via point, and when the calculated risk meets a preset reference (for example, when the risk for each via point is equal to or less than a threshold value Th1) or when a total value of the calculated risks meets a preset reference (for example, when the total value of the risks is equal to or less than a threshold value Th2), a route that meets the reference is adopted as a target route along which the mobile body 100 moves. Here, it is assumed that it is more likely that the mobile body 100 should not enter or approach a corresponding via point as the risk has a higher value, and it is more favorable for the mobile body 100 to pass through a corresponding via point as the risk has a value getting closer to zero. For this reason, generally, the risk has a higher value as the mobile body is closer to a position of a recognized object, while the risk has a lower value as the mobile body is farther away from the position of the recognized object.

The drive control unit 206 controls the motors (the first motor 122 and the second motor 132), the brake device 136, and the steering device 138 so that the mobile body 100 travels along the route generated by the route generation unit 204.

### [Route Generation]

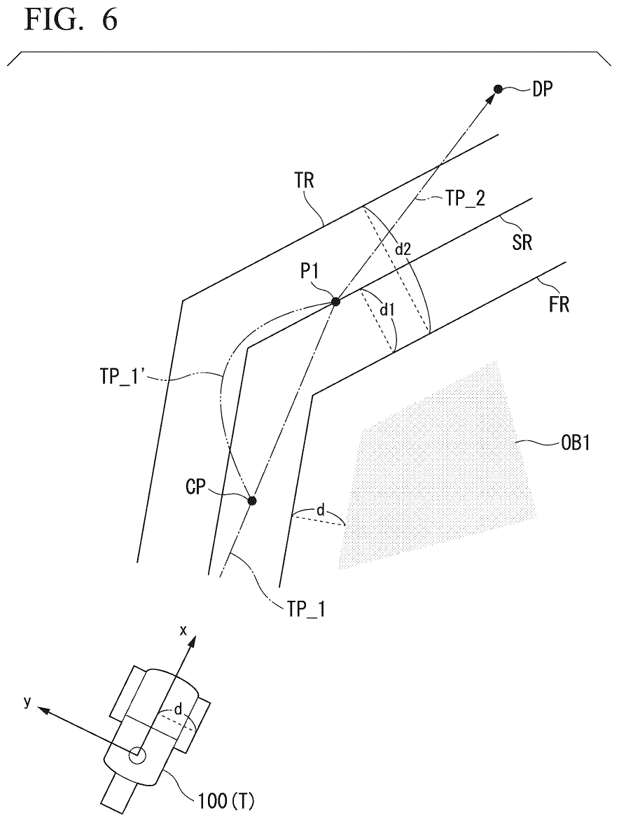

FIG. 6 is a diagram which shows an example of the route generated by the route generation unit 204. In FIG. 6, a combination TP of the dashed dotted lines TP_1 and TP_2 indicates a route initially generated by the route generation unit 204, a symbol P1 indicates a via point that constitutes the generated route TP, and a symbol DP indicates a destination. The destination DP may be a specified point diagonally behind a user U when the mobile body 100 is traveling in the following mode, or may be a point set by the user or a point within a specified range from the current position with the point set by the user as the final destination when the mobile body 100 is traveling in the guidance mode. In addition, the destination DP may be one of the plurality of via points (that is, a via point P2 next after a via point P1 in FIG. 6).

As described above, the route initially generated by the route generation unit 204 is a route that allows the mobile body 100 to reach the destination reasonably, taking into account the forward direction and risk of the mobile body 100. However, the route initially generated by the route generation unit 204 is generated by regarding the mobile body 100 as a mass point, as in the conventional technology, and therefore, when the mobile body 100 travels along the route, the mobile body 100 may come too close to or collide with an obstacle.

### [Setting of Multi-Layered Area]

In light of the circumstances described above, when an obstacle is included in the surrounding conditions recognized by the recognition unit 202, the present invention sets a first area using the obstacle as a reference, a second area positioned outside the first area using the obstacle as a reference, and a third area positioned outside the second area using the obstacle as a reference, and determines whether to modify the route on the basis of at least one of the first area, the second area, and the third area and the initially generated route.

More specifically, in FIG. 6, a symbol OB1 represents an obstacle in the surrounding conditions recognized by the recognition unit 202, a symbol FR represents a line that defines a first area using the obstacle OB1 as a reference, a symbol SR represents a line that defines a second area that is positioned outside the first area using the obstacle OB1 as a reference, and a symbol TR represents a line that defines a third area that is positioned outside the second area using the obstacle OB1 as a reference. A first area FR is defined as an area obtained by expanding an area representing the obstacle OB1 by a portion corresponding to a radius d of the mobile body 100. A second area SR is defined as an area obtained by expanding the area representing the obstacle OB1 by a portion obtained by adding a first predetermined distance d1 to the radius d of the mobile body 100. A third area TR is defined as an area obtained by expanding the area representing the obstacle OB1 by a portion obtained by adding a second predetermined distance d2, which is equal to or greater than the first predetermined distance d1, to the radius d of the mobile body 100. That is, the first area FR is an area in which the mobile body 100 is required to stop to avoid a collision with the obstacle OB1, the second area SR is an area in which the mobile body 100 travels with a normal interval from the obstacle OB1, and the third area TR is an area in which the mobile body 100 travels with a sufficient interval from the obstacle OB1.

First, the drive control unit 206 causes the mobile body 100 to travel along the route TP initially generated by the route generation unit 204. When the mobile body 100 does not come into contact with the first area FR while traveling, the mobile body 100 will reach the destination DP via the via point P1 shown in FIG. 6. On the other hand, when the mobile body 100 comes into contact with the first area FR, the route generation unit 204 determines to modify the initially generated route TP on the basis of the first area FR, the second area SR, and the third area TR. The route generation unit 204 modifies the route TP so that the mobile body does not pass through the first area FR and preferentially passes through the third area TR over the second area SR. FIG. 6 represents an example in which the mobile body 100 comes into contact with the first area FR at a point CP, and therefore a route TP_1 from the contact point CP to the via point P1 is modified to a route TP_1′ so that the mobile body 100 passes through the third area TR as an example. As a result, the mobile body 100 can travel with a sufficient interval from the obstacle OB1. That is, according to the present embodiment, it is possible to generate a route while preventing a robot from getting close to an obstacle excessively.

In FIG. 6, only the route TP_1 from the contact point CP to the via point P1 is modified, but the present invention is not limited to such a configuration, and the route generation unit 204 may modify a route TP_2 so that switching from the route TP_1 to the route TP_2 is smoothly performed, taking into account the forward direction of the mobile body 100 when the mobile body has entered the via point P1 along the route TP_1′.

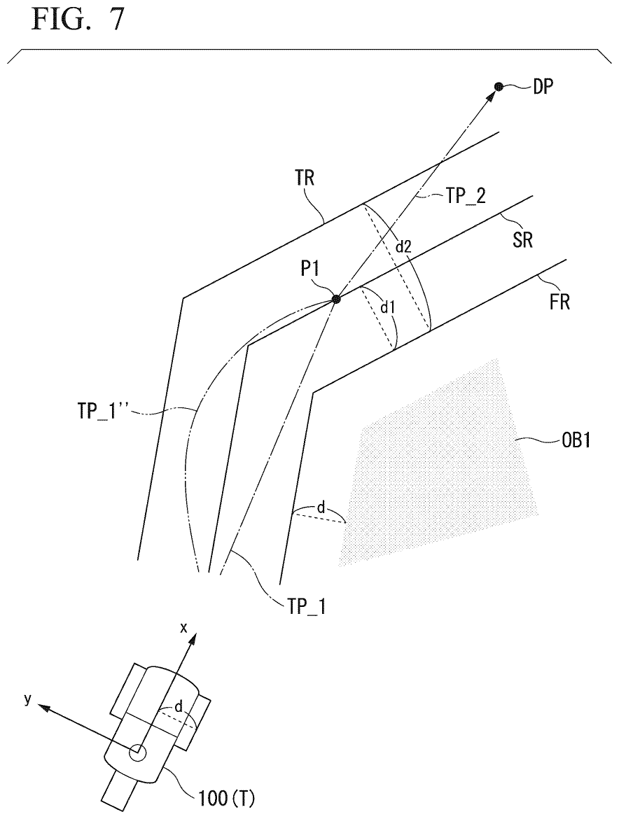

FIG. 7 is a diagram which shows another example of the route generated by the route generation unit 204. FIG. 6 describes, as an example, a case where the route is modified at a timing when the mobile body 100 comes in contact with the first area FR. In another aspect, when the surrounding conditions recognized by the recognition unit 202 includes an obstacle, the route generation unit 204 may determine in advance, for example, by simulation, whether the mobile body 100 will come into contact with the first area FR on the basis of the initially generated route TP and the first area FR set using the obstacle as a reference, and may determine to modify the route TP when it is determined that the mobile body 100 will come into contact with the first area FR. FIG. 7 shows an example in which the route generation unit 204 modifies the route TP_1 to a route TP_1″ so that the mobile body 100 passes through the third area TR before traveling along the initially generated route TP.

In this manner, the route generation unit 204 modifies the initially generated route TP so that the mobile body preferentially passes through the third area TR over the second area SR. However, since the third area TR has a larger area than the second area SR, it may not be possible to modify the route TP to cause it to pass through the third area TR, for example, due to presence of an obstacle OB2 separate from the obstacle OB1. In such a case, the route generation unit 204 may modify the route TP to cause it to pass through the second area TR.

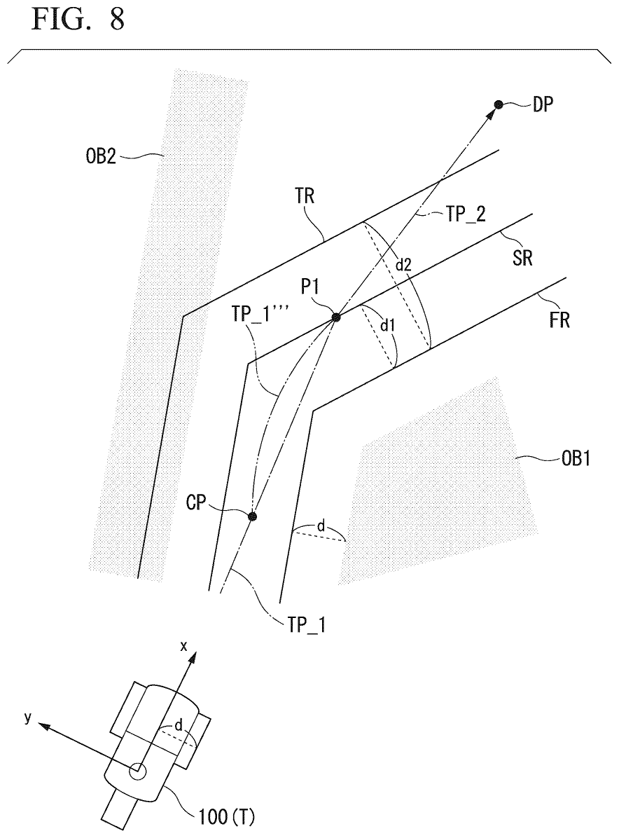

FIG. 8 is a diagram which shows another example of the route generated by the route generation unit 204. FIG. 8 shows, as an example, a case in which the obstacle OB2 is recognized in addition to the obstacle OB1. First, the drive control unit 206 causes the mobile body 100 to travel along the route TP initially generated by the route generation unit 204, and the mobile body 100 comes into contact with the first area FR at the point CP. At this time, as shown in FIG. 8, the third area TR includes the obstacle OB2, while the second area SR does not include the obstacle OB2. Therefore, the route generation unit 204 modifies the route TP to a route TP″ so that the mobile body passes through the second area SR without passing through the first area FR. As a result, it is possible to apply the present invention even on narrow roads while preventing a robot from getting close to an obstacle excessively.

Note that in the description of FIG. 8, an example is described in which the route generation unit 204 modifies the route only within a range of the second area SR when the third area TR includes the obstacle OB2, but the present invention is not limited to such a configuration, and the route may be modified using the third area TR as long as there is no contact with the obstacle OB2 (or as long as an interval from the obstacle OB2 is maintained to be equal to or greater than a predetermined value).

Furthermore, FIGS. 6 to 8 show a case in which the route generation unit 204 sets a first area FR, a second area SR, and a third area TR only for the obstacle OB1, and modifies the route TP. In another aspect, the route generation unit 204 may set a first area FR, a second area SR, and a third area TR for all recognized obstacles, and modify the route TP so that the mobile body preferentially passes through the third area TR over the second area SR while avoiding contact with all of the set first areas FR.

### [Flow of Processing]

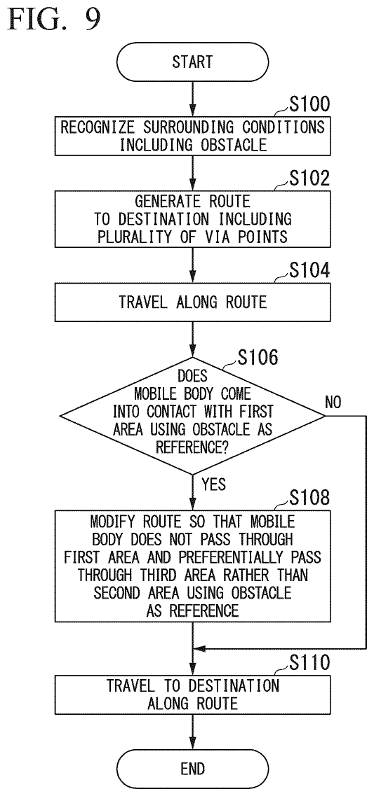

A flow of processing executed by the control device 200 will be described below with reference to FIG. 9. FIG. 9 is a flowchart which shows an example of the flow of processing executed by the control device 200. The processing shown in FIG. 9 is executed while the mobile body 100 is traveling in the following mode or guidance mode.

First, the recognition unit 202 recognizes the surrounding conditions including an obstacle on the basis of at least on an image of the surrounding conditions of the mobile body 100 (step S100). Next, the route generation unit 204 generates a route from the mobile body 100 to a set destination, including a plurality of via points, on the basis of the recognized surrounding conditions and the destination (step S102). Next, the drive control unit 206 causes the mobile body 100 to travel along the generated route (step S104).

Next, the route generation unit 204 determines whether the mobile body 100 has come into contact with a first area using the recognized obstacle as a reference (step S106). When it is determined that the mobile body 100 has come into contact with the first area using the recognized obstacle as a reference, the route generation unit 204 modifies the route so that the mobile body does not pass through the first area, and preferentially passes through a third area over a second area using the obstacle as a reference (step S108). Next, the drive control unit 206 causes the mobile body 100 to travel to the destination along the modified route (step S110). On the other hand, when it is determined that the mobile body 100 will not come into contact with the first area using the recognized obstacle as a reference, in step S110, the drive control unit 206 causes the mobile body 100 to travel to the destination along the route initially generated by the route generation unit 204 (step S110).

According to the present embodiment described above, when the surrounding conditions of the mobile body 100 includes an obstacle, the route of the mobile body 100 is modified on the basis of the first area using the obstacle as a reference, the second area positioned outside the first area using the obstacle as a reference, and the third area positioned outside the second area using the obstacle as a reference. As a result, it is possible to generate a route while preventing a robot from getting close to an obstacle excessively.

The embodiment described above can be expressed as follows.

A mobile body control device includes a storage medium that stores computer-readable instructions, and a processor that is connected to the storage medium, wherein the processor executes the computer-readable instructions to recognize surrounding conditions of a mobile body on the basis of at least an image of the surrounding conditions of the mobile body, generate a route composed of via points to be passed through by the mobile body, which is a route from the mobile body to a destination, on the basis of the recognized surrounding conditions and the set destination, control the mobile body so that the mobile body moves along the generated route to the destination via the via points, and when the surrounding conditions include an obstacle, generate the route on the basis of a first area using the obstacle as a reference, a second area positioned outside the first area using the obstacle as a reference, and a third area positioned outside the second area using the obstacle as a reference.

As described above, a form for carrying out the present invention has been described using an embodiment, but the present invention is not limited to such an embodiment, and various modifications and substitutions can be made within a range not departing from the gist of the present invention.

What is claimed is:

1. A mobile body control device comprising:
a storage medium configured to store computer-readable instructions, and
a processor that is connected to the storage medium, wherein
the processor executes the computer-readable instructions to:
recognize surrounding conditions of a mobile body on the basis of at least an image of the surrounding conditions of the mobile body,
generate a route composed of via points to be passed through by the mobile body, which is a route from the mobile body to a destination, on the basis of the recognized surrounding conditions and the set destination,
control the mobile body so that the mobile body moves along the generated route to the destination via the via points, and
when the surrounding conditions include an obstacle, determine whether to modify the route on the basis of at least one of a first area using the obstacle as a reference, a second area positioned outside the first area using the obstacle as a reference, and a third area positioned outside the second area using the obstacle as a reference, and the route.

2. The mobile body control device according to claim 1,
wherein the processor determines to modify the route when the mobile body has come into contact with the first region while moving along the route.

3. The mobile body control device according to claim 1,
wherein the processor determines to modify the route when it is determined that the mobile body has come into contact with the first region under an assumption that the mobile body has moved along the route.

4. The mobile body control device according to claim 1,
wherein the processor modifies the route so that the mobile body does not pass through the first area and preferentially passes through the third area over the second area.

5. The mobile body control device according to claim 1,
wherein the processor modifies the route so that the mobile body passes through the second area without passing through the first area when the second area does not include another obstacle even if the third area includes the other obstacle.

6. The mobile body control device according to claim 1,
wherein the first area is an area obtained by expanding an area representing the obstacle by a portion corresponding to a radius of the mobile body.

7. The mobile body control device according to claim 1,
wherein the second area is an area obtained by expanding the area representing the obstacle by a portion obtained by adding a first predetermined distance to the radius of the mobile body.

8. The mobile body control device according to claim 7,
wherein the third area is an area obtained by expanding the area representing the obstacle by a portion obtained by adding a second predetermined distance, which is equal to or greater than the first predetermined distance, to the radius of the mobile body.

9. A mobile body control method comprising:
by a computer,
recognizing surrounding conditions of a mobile body on the basis of at least an image of the surrounding conditions of the mobile body;
generating a route composed of via points to be passed through by the mobile body, which is a route from the mobile body to a destination, on the basis of the recognized surrounding conditions and the set destination;
controlling the mobile body so that the mobile body moves along the generated route to the destination via the via points; and
when the surrounding conditions include an obstacle, determining whether to modify the route on the basis of at least one of a first area using the obstacle as a reference, a second area positioned outside the first area using the obstacle as a reference, and a third area positioned outside the second area using the obstacle as a reference, and the route.

10. A computer-readable non-transitory storage medium that stores a program causing a computer to execute:
recognizing surrounding conditions of a mobile body on the basis of at least an image of the surrounding conditions of the mobile body,
generating a route composed of via points to be passed through by the mobile body, which is a route from the mobile body to a destination, on the basis of the recognized surrounding conditions and the set destination,
controlling the mobile body so that the mobile body moves along the generated route to the destination via the via points, and
when the surrounding conditions include an obstacle, determining whether to modify the route on the basis of at least one of a first area using the obstacle as a reference, a second area positioned outside the first area using the obstacle as a reference, and a third area positioned outside the second area using the obstacle as a reference, and the route.
